(19) United States
(12) Patent Application Publication
(10) Pub. No.: US 2018/0225488 A1
(43) Pub. Date: Aug. 9, 2018

(54) METHOD FOR CHECKING AN IDENTITY OF A PERSON

(71) Applicant: Veridos GmbH, Berlin (DE)

(72) Inventor: Thomas Aichberger, Oberhaching (DE)

(21) Appl. No.: 15/572,496

(22) PCT Filed: May 10, 2016
(86) PCT No.: PCT/EP2016/000761

§ 371 Date: Apr. 9, 2018

(30) Foreign Application Priority Data
May 11, 2015 (DE) 10 2015 006 091.0

(51) Int. Cl. G06K 7/10; G06K 7/14; G06Q 50/26; H04L 9/32

(52) U.S. Cl. CPC G06K 7/10386; G06K 7/1417; G06K 2007/10485; H04L 9/3242; G06Q 50/265

(57) ABSTRACT

The present invention relates to a method for checking an identity of an individual, which method comprises the following steps: a) presenting an optically readable code (14) with a mobile device (10); b) reading the optically readable code (14) with an optical reading device (20); c) extracting the data contained in the optically readable code (14); d) verifying the data contained in the optically readable code (14); and e) displaying at least a portion of the data on the optical reading device (20). The steps c) to e) are executed by the optical reading device (20).

The present invention relates to a method for checking an identity of an individual, an optical reading device and a system that comprises at least a mobile device and an optical reading device.

To date, the identity of an individual is checked using an identification document allocated to the individual. Such an identification document can be, for example, an identity paper (personal identity card or passport), a driving license or a social security card. Checking whether the identification document is authentic and not manipulated is normally difficult. Checking the identification document in greater detail can be carried out only with auxiliary means, which, for example, identify security features applied to or introduced into the identification document. For checking, the identification document must be handed over to an individual performing the check, e.g. a police officer.

In connection with the now widespread smartphones, the idea is to realize an identification document in electronic format on the smartphone or another mobile terminal (generally: mobile submission) with the aid of a mobile smartphone application. However, handing over the smartphone to the inspecting individual for checking the identity of an individual by means of a mobile smartphone application is undesirable. The primary arguments against this are data security principles, but also the concern that the inspecting individual can retrieve personal content on the smartphone during the inspection. Besides the lack of legal bases for an involuntary “search” of the smartphone, liability issues concerning any damage following the handover of the smartphone to the inspecting individual are also unsettled.

Depending on the configuration of the mobile smartphone application, communication channels to external equipment (e.g. servers) are required in order to verify the identification data contained in the mobile smartphone application. Due to the differing penetration of different communication standards for mobile devices, it is difficult to establish a communication interface with the widest possible prevalence. Furthermore, there then exists the imperative that, during an inspection, a data connection to the external apparatus must be required.

It is the object of the present invention to specify a method for checking an identity of an individual, which method uses a mobile identification on a mobile device without the mobile device having to be handed over to an inspecting individual for inspection. A further object of the present invention consists in specifying an optical reading device and a system, consisting of a mobile device and an optical reading device, that are suitable for realizing the method according to the present invention.

Said objects are solved by a method according to the features of claim 1, an optical reading device according to the features of claim 14 and a system according to the features of claim 16. Advantageous embodiments result from the dependent claims.

The inventive method for checking an identity of an individual comprises the following steps: a) presenting an optically readable code with a mobile device; b) reading the optically readable code with an optical reading device; c) extracting the data contained in the optically readable code; d) verifying the data contained in the optically readable code; e) displaying at least a portion of the data on the optical reading device. Here, the steps c) to e) are executed by the optical reading device.

The method enables an inspecting body, at the inspecting location, to establish the identity of an individual that uses a mobile identification document on a mobile device, and to check whether said identity matches up with the real individual. In this process, it is not required that the mobile device be handed over to the inspecting individual. Furthermore, the method is offline-capable. That is, to check the identity of the individual, it is not required that the optical reading device establish communication with another external apparatus (e.g. a server). The last-mentioned characteristic brings with it the advantage that the checking of the identity is manipulatable by an interrupter only with difficulty or not at all.

The method permits a simple checking of the identity of an individual, since only little equipment is required. To carry out the method, it is sufficient to provide the mobile device for presenting the optically readable code and the optical reading device. The method facilitates simple operation that is logically apparent. Because of the simple operation, high acceptance can be assumed. This is especially true in such countries as those that use no passport or no personal identity card for identification, but rather a driving license or a social security card instead. The so-called “Iowa” ID, for example, can be advantageously refined in this way.

Because of the simple operation, the method can be used for a wide array of application purposes. For example, the mobile identification document that is displayed as an optical code can replace a personal identity card. Furthermore, with the optical code, access to event locations, such as bars, discotheques, etc., and to shops, such as businesses selling alcohol, tobacconists, etc., can be checked.

The corresponding checks of the identity of the individual are performed with or on the optical reading device. Here, it is not required that the optical reading device store a secret. Instead, the method is based on checking a chain of identity features and checking whether the data contained in the optically readable code is authentic.

The method does not constitute a proprietary solution, but rather can be solved with known methods and cryptographic mechanisms that are already present in many mobile devices and optical reading devices today.

A further advantage consists in the fact that no clone protection is needed, since the individual whose identity is to be checked stands before the inspecting individual for identification. Here, in the context of the check, it becomes apparent whether the data conveyed fits the inspecting individual or not.

According to an expedient embodiment, the optically readable code is a QR code. Particularly QR codes version 25 and larger are used. In principle, all versions of QR codes can come into use within the scope of the present invention. However, depending on the size and/or resolution of the display device of the mobile devices, it must be verified that the recognition and readout with the optical reading device is ensured. A QR code of version 25 or larger permits, on the one hand, good and fast recognition of the optical code by the optical reading device and comprises, on the other hand, a sufficiently large storage capacity to encompass all relevant information that is associated with an identity of an individual.

According to an expedient embodiment, the optical reading device is a mobile device having a camera device and/or having a camera device. In particular, the optical reading device can be a smartphone, a tablet PC or other, application-specific mobile device having a camera device.

Within the scope of the present invention, a mobile device can be understood to be a smartphone, a tablet PC, a computer or any other mobile apparatus that features the possibility to be able to display or output an optically readable code on a display device.

The optically readable code can comprise a plurality of optically readable codes. In particular, the optically readable code can comprise a plurality of codes that permit sequential optical readout. In the last-mentioned variant, it is possible to store in the optically readable code larger data volumes for the identity, and optionally additional data, of an individual, as well as for transmission, in that said data is distributed across multiple optically readable codes.

The step of extracting can comprise the allocation of the data contained in the optically readable code to different data segments. In this way, the data structure of the optical code is transferred to a data structure that is processed by the optical reading device.

The different data segments can comprise at least one data group, one signature and/or one document signing certificate. The at least one of the data groups can comprise data that includes at least one piece of information from the following group: document type, document number, issuing authority, holder, nationality, date of birth, place of birth, sex, date of validity.

According to one expedient embodiment, the step of verifying comprises the calculation of at least one hash value for each of the data groups and the concatenation of the hash values to form a calculated hash value. Further, in one embodiment, the step of verifying comprises the decrypting of the signature using an asymmetric, public key and results in a mobile hash value.

In a further embodiment, the step of verifying comprises the comparison of the calculated hash values with the mobile hash value.

In a further embodiment, the step of verifying further comprises the verification of the document signing certificate using a key available to the optical reading device, especially a site-specific key available to the optical reading device.

At least one of the data groups can comprise data that renders an image, especially a biometric photo, of the holder of the optically readable code and that is displayed on the optical reading device. In this way, the inspecting individual is enabled to check whether the image of the optically readable code matches up with the individual presenting the mobile device having the optically readable code.

The optically readable code can be provided by an issuing institution, the issuing institution introducing the signature and/or the document signing certificate into the optically readable code. In this way, a high level of protection against manipulation of the optically readable code is ensured.

An optical reading device according to the present invention is developed for executing the method according to one of the preceding claims. As described, the optical reading device is a mobile device having a camera device and/or a reader having a camera device. In the simplest case, the optical reading device is a smartphone or a tablet PC. It can also be an application-specific mobile apparatus that serves the sole purpose of reading and evaluating the optically readable code. For this purpose, it is expedient that the optical reading device have, besides the camera device, a display device to not only binarily (e.g. via individual lights) give information about the correctness of the identity of an individual, but also to render the image stored in the optically readable code.

According to a further embodiment, the use of an optical reading device of the kind described above in a method having the features of this description is provided.

Finally, the present invention comprises a system having at least a mobile device and an optical reading device, the optical reading device being developed for executing a method according to one of the preceding claims.

The present invention is explained in greater detail below by reference to an exemplary embodiment in the drawing. Shown are:

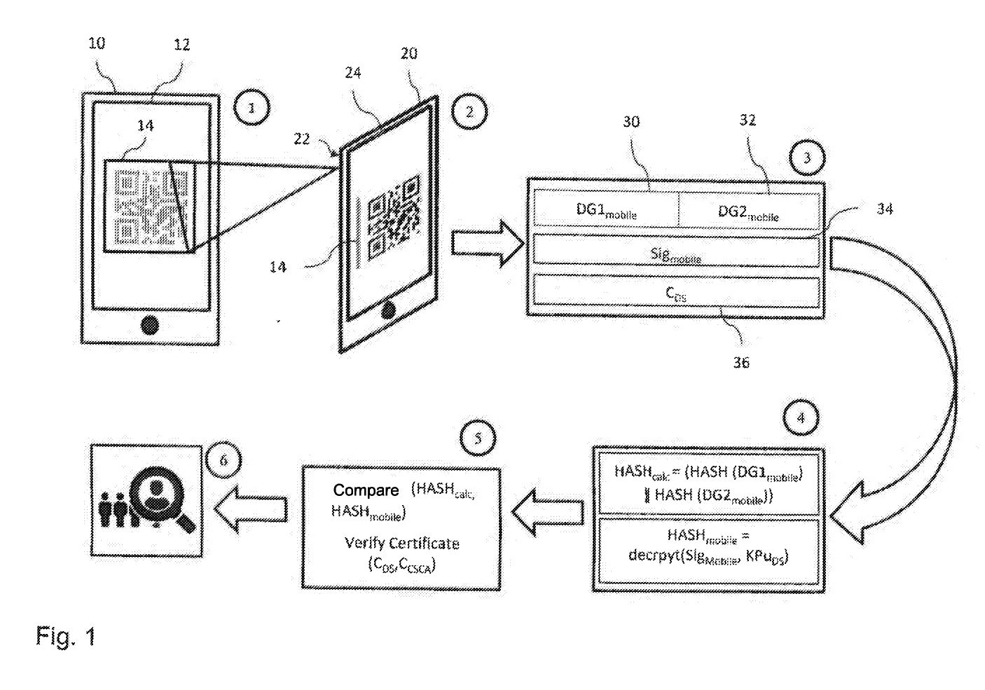

FIG. 1 a schematic diagram of the sequence of a method according to the present invention for checking an identity of an individual;

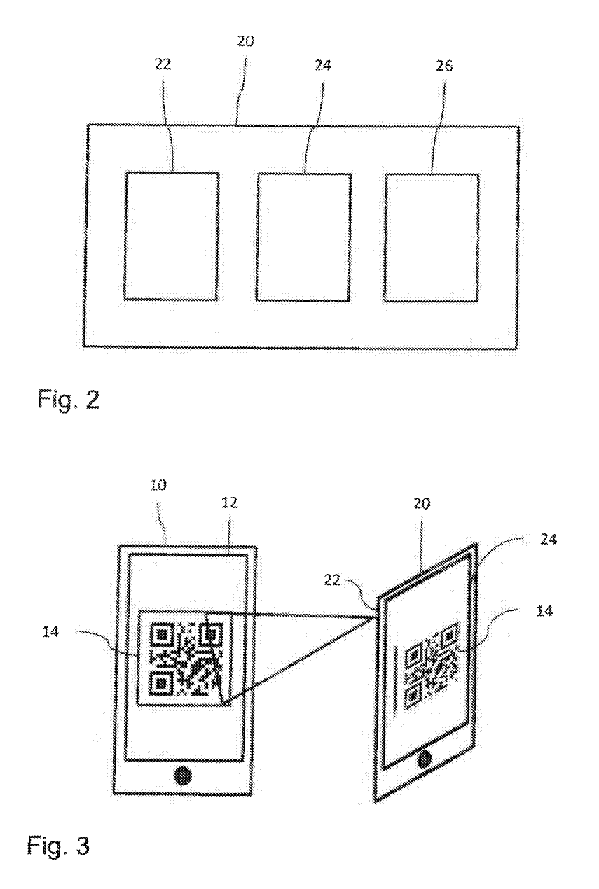

FIG. 2 a schematic diagram of an optical reading device according to the present invention;

FIG. 3 a system according to the present invention, consisting of a mobile device and an optical reading device for carrying out the method according to the present invention; and

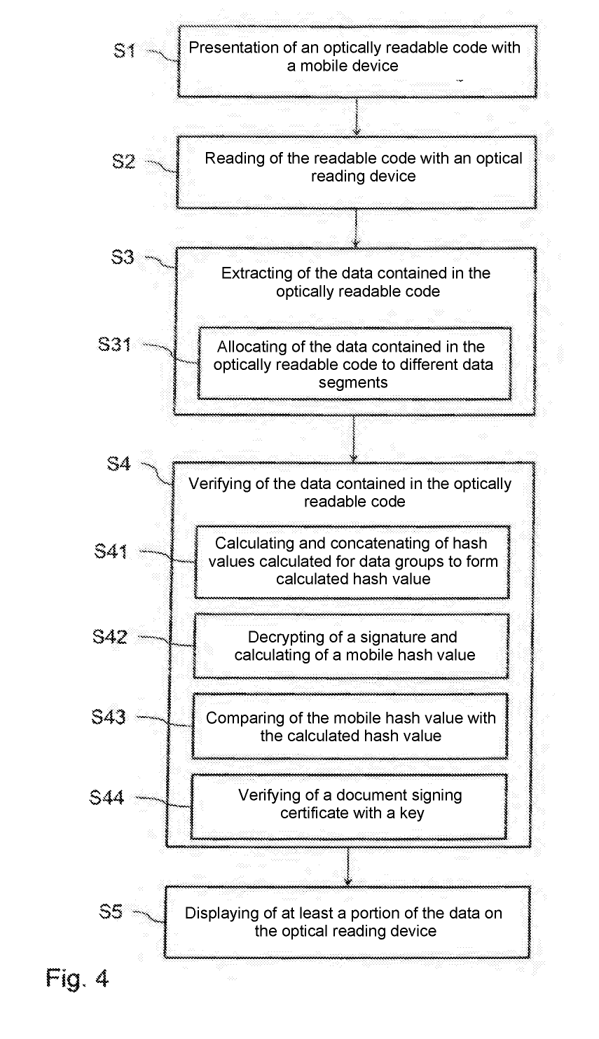

FIG. 4 a flowchart of the method according to the present invention, in schematic diagram.

FIG. 1 shows, in a schematic diagram, the basic principle of the method according to the present invention for checking an identity of an individual. The data identifying an individual is stored in electronic form in a mobile device 10, e.g. in the form of a smartphone or tablet PC. The use of the mobile device 10, on which a mobile application is executed to display information identifying the individual, enables an inspecting individual to check whether the identity matches up with the real individual. For this, it is not necessary to hand over the mobile device 10 to the inspecting individual. As will likewise become clear from the following description, for checking the identity, it is also not required that a communication channel to an external device be established. This means that the identity check can be done offline. In this way, an interference of the identity check is impeded.

The information identifying an individual is displayed in the form of a barcode, e.g. a QR code version 25 or above, as an optical code 14 on a display 12 of the mobile device 10 (“1” in FIG. 1). Various personal data is included in the barcode in hashed and signed form: information about the document type and/or the document number and/or the issuing authority and/or the holder and/or the nationality and/or the date of birth and/or the place of birth and/or the sex and/or the date of validity of the proof of identity. Of the information listed, a single piece or multiple pieces of information can be contained in the optical code 14 in any arbitrary combination. The information mentioned is allocated to a first data group DG1_{mobile}. As further information, the barcode can comprise an image of the holder of the optical code 14, e.g. in the form of a biometric code. This information about the image is allocated to a second data group DG2_{mobile}.

The optical code 14 thus comprises, in the first data group DG1_{mobile}, biographical data of the holder of the optical code, and in a second data group DG2_{mobile}, an image of the holder of the optical code. Further, the optical code 14 includes a digital signature Sig_{mobile} via the first and second data group DG1_{mobile} and DG2_{mobile}, and a document signing certificate C_{DS}.

To the extent that the information to be made available for a personal identification is too large for a single barcode (QR code of a certain version), multiple barcodes can be displayed sequentially on the mobile device 10.

The optical code 14 comprising one or more pieces of information in the form of one or more QR codes is read according to “2” by an optical reading device 20. For this, the optical reading device has a camera device 22 with which the optical code 14 depicted on the display 12 of the mobile device 10 can be acquired. To visually check that a reading is correct, the optical code 14 can be displayed on a display 24 of the optical reading device 20. A processing occurs in a processing unit, not further shown in FIG. 1, of the optical reading device.

A schematic diagram of the optical reading device 20, e.g. likewise in the form of a smartphone, a tablet PC or an application-specific mobile device, with its camera device 22, the display 24 and processing unit 26, is further depicted in FIG. 2.

The operation of the optical reading device 20 is done by an inspector, depending on the situation e.g. by an official or an individual monitoring an admission, or a cashier.

According to “3” in FIG. 1, the optical code 14 is extracted by the optical reading device 20, the data included in the optical code 14 being allocated to different data segments 30, 32, 34, 36. As shown for “3” in FIG. 1, the first data group DG1_{mobile} is allocated to the data segment 30, the second data group DG2_{mobile} to the data segment 32, the digital signature Sig_{mobile} to the data segment 34, and the document signing certificate C_{DS} to the data segment 36. The allocation to the data segments 30, 32, 34, 36 serves the further processing of the information in the optical code 14.

According to “4” in FIG. 1, the optical reading device 20 calculates a so-called calculated hash value HASH_{calc} from the information in the first data group (HASH(DG1_{mobile})) and the information in the second data group (HASH(DG2_{mobile})) and concatenates these to form the calculated hash value HASH_{calc}. Furthermore, the optical reading device 20 decrypts the signature Sig_{mobile} using an asymmetrical, public key KPu_{DS}. The result of the decrypting yields a mobile hash value HASH_{mobile}. The signature Sig_{mobile} is provided by an issuing institution using an asymmetrical, private key KPr_{DS} and is introduced into the optically readable code together with the document signing certificate C_{DS}.

According to “5” in FIG. 1, a comparison of the calculated hash value HASH_{calc} with the mobile hash value HASH_{mobile} and a verification of the document signing certificate C_{DS} using a key C_{CSCA} available to the optical reading device 20 occur. If said verifications that were carried out were correct, this ensures that the content of the optical code is trustworthy and the information allocated to data groups DG1_{mobile} and DG2_{mobile} is authentic and unmodified.

Further, according to “6” in FIG. 1, from the second data group DG2_{mobile}, the image of the holder of the optically readable code 14 can be rendered on the display 24 of the optical reading device 20. The image can be included in the second data group DG2_{mobile} as a JPG, for example. Here, the size of the image should not exceed the maximum capacity of a QR code including the first data group DG1_{mobile}, the digital signature Sig_{mobile} and the document signing certificate C_{DS}. Otherwise, as described, multiple QR codes should be displayed on the mobile device. It is expedient to maintain the original image aspect ratio. Furthermore, it is expedient to provide, in the optical code 14, a colored image of the holder of the optical code. Said image should expediently not fall below the size 60×80 pixels.

The data required to produce the optical code 14 is expediently provided by the issuing institution. The data provided by said institution comprises the first and the second data group DG1_{mobile}, DG2_{mobile}, and the digital signature Sig_{mobile}, the digital signature resulting from an encrypting of a hash value via the first data group DG1_{mobile} and a hash value via the second data group DG2_{mobile} and a concatenation of said two hash values. Here, an asymmetrical, private key KPr_{DS} is used for encrypting. Further, the document signing certificate C_{DS} is provided. The image that is encrypted in the second data group DG2_{mobile} should have a size as said image is on a paper data carrier.

FIG. 3 shows, in a schematic diagram, the system according to the present invention consisting of the already described mobile device 10 and the likewise already described optical reading device 20 that are developed according to the above description. Besides the possibility to be able to capture the optical code 14 by camera device 22, in particular, no data connection to an external server and the like is needed.

FIG. 4 shows a flowchart in which the individual method steps are illustrated again.

In step S1, a presentation of an optically readable code with a mobile device takes place. In step S2, a reading of the readable code with an optical reading device takes place. In step S3, an extracting of the data contained in the optically readable code takes place, an allocating of the data contained in the optically readable code to different data segments taking place in step S31. In step S4, a verifying of the data contained in the optically readable code takes place. Here, step S4 comprises steps S41 to S44. In S41, a calculating and concatenating of hash values calculated for data groups takes place to form a calculated hash value. In S42, a decrypting of a signature and calculating of a mobile hash value takes place. In S43, a comparing of the mobile hash value with the calculated hash value takes place. In S44, a verifying of a document signing certificate with a key takes place. In S5, the displaying of at least a portion of the data on the optical reading device takes place.

1. A method for the offline checking of an identity of an individual, comprising the following steps:
a) presenting an optically readable code (14) with a mobile device (10);
b) reading the optically readable code (14) with an optical reading device (20);
c) extracting the data contained in the optically readable code (14);
d) verifying the data contained in the optically readable code (14);
e) displaying at least a portion of the data on the optical reading device (20), the steps c) to e) being executed by the optical reading device (20).

2. The method according to claim 1, characterized in that the checking of the identity of the individual is performed solely by the optical reading device (20), without communication with an external apparatus.

3. The method according to claim 1, characterized in that the steps c) to e) are executed by the optical reading device (20) in communicative isolation from the outside world.

4. The method according to claim 1, characterized in that the optically readable code (14) is a QR code.

5. The method according to claim 1, characterized in that the optical reading device (20) is a mobile device having a camera device (22) and/or is a reader having a camera device (22).

6. The method according to claim 1, characterized in that the optically readable code (14) comprises a plurality of optically readable codes, especially a plurality of codes that permit optical readout in chronological sequence.

7. The method according to claim 1, characterized in that the step of extracting comprises the allocation of the data contained in the optically readable code (14) to different data segments.

8. The method according to claim 7, characterized in that the different data segments comprise at least one data group (DG1_{mobile}, DG2_{mobile}), a signature (Sig_{mobile}) and/or a document signing certificate (C_{DS}).

9. The method according to claim 1, characterized in that the step of verifying comprises the calculation of at least one hash value for each of the data groups and the concatenation of the hash values to form a calculated hash value (HASH_{calc}).

10. The method according to claim 9, characterized in that the step of verifying further comprises the decrypting of the signature (Sig_{mobile}) using an asymmetrical, public key (KPu_{DS}) and results in a mobile hash value (HASH_{mobile}).

11. The method according to claim 9, characterized in that the step of verifying further comprises the comparison of the calculated hash value (HASH_{calc}) with the mobile hash value (HASH_{mobile}).

12. The method according to claim 1, characterized in that the step of verifying further comprises the verification of the document signing certificate (C_{DS}) using a key (C_{CSCA}) available to the optical reading device (20), especially a site-specific key available to the optical reading device.

13. The method according to claim 1, characterized in that at least one of the data groups (DG1_{mobile}, DG2_{mobile}) comprises data that renders an image, especially a biometric photo, of the holder of the optically readable code, which data is presented on the optical reading device.

14. The method according to claim 1, characterized in that at least one of the data groups (DG1_{mobile}, DG2_{mobile}) comprises data that comprises at least one piece of information from the following group: document type, document number, issuing authority, holder, nationality, date of birth, place of birth, sex, date of validity.

15. The method according to claim 1, characterized in that the optically readable code (14) is provided by an issuing institution, the issuing institution introducing the signature and/or the document signing certificate into the optically readable code (14).

16. An optical reading device that is developed for executing the method according to claim 1.

17. A use of an optical reading device in a method according to claim 1.

18. A system comprising at least a mobile device (10) and an optical reading device (20), the optical reading device (10) being developed for executing a method according to claim 1.
